(19) United States
(12) Patent Application Publication
(10) Pub. No.: US 2017/0059781 A1
(43) Pub. Date: Mar. 2, 2017

(54) OPTICAL CIRCUIT BOARD ASSEMBLIES

(71) Applicant: Corning Optical Communications LLC, Hickory, NC (US)

(72) Inventors: Davide Domenico Fortusini, Ithaca, NY (US); Christopher Paul Lewallen, Hudson, NC (US); James Phillip Luther, Hickory, NC (US)

(21) Appl. No.: 15/237,723

(22) Filed: Aug. 16, 2016

Related U.S. Application Data
(62) Division of application No. 62/211,341, filed on Aug. 28, 2015.

(51) Int. Cl. G02B 6/32; G02B 6/30; G02B 6/42

(52) U.S. Cl. CPC G02B 6/32; G02B 6/428; G02B 6/4244; G02B 6/322; G02B 6/30

(57) ABSTRACT

Optical circuit board assemblies having one or more lens bodies are disclosed. In one embodiment, the assembly comprises a composite circuit board comprising a glass-substrate and a non-glass substrate with the non-glass substrate having at least one cutout that exposes a portion of the glass substrate and at least one optical trace comprising one or more optical interfaces on the composite circuit board. The one or more optical interfaces of the composite circuit board are in optical communication with the one or more lens bodies. Other optical circuit board assemblies may include other features such as a bezel mount attached to the composite circuit board or an attachment structure secured to the composite circuit board.

### CROSS-REFERENCE TO RELATED APPLICATIONS

This application claims the benefit of priority to U.S. Provisional Application No. 62/211,341, filed on Aug. 28, 2015, and is incorporated herein by reference.

### BACKGROUND

Field

The technology of the disclosure relates to optical circuit board assemblies having a composite circuit board comprising a glass substrate and a non-glass substrate for optical communication.

Technical Background

Benefits of devices having optical waveguides include extremely wide bandwidth and low noise operation. Because of these advantages, devices with optical waveguides are increasingly being used for a variety of applications, including but not limited to broadband voice, video, and data transmission. For example, fiber optic networks employing optical fiber are being developed and used to deliver voice, video, and data transmissions to subscribers over both private and public networks.

For example, optical fiber may be employed in data distribution centers or central offices for telecommunications and storage systems applications. These applications include, but are not limited to, server farms, such as for web page accesses, and remote storage equipment, such as for backup storage purposes, as examples. However, today's networks still use transceivers mounted at the edge of printed circuit boards for converting optical signals to electrical signals and vice-versa such as the electrically-based server blades in communications network. As bandwidth demands continue to increase there will be a need for reducing the length of the electrical traces carrying the high-speed signals by positioning the transceivers “on-board” so that the transceivers performing the optical/electrical conversion are closer to the processor integrated circuit. As such, there will be a need to provide optical traces in circuit boards for transporting the optical signals between the edge of the board and the transceivers. To provide for efficient management and organization of equipment such as server blades, they are organized and mounted in equipment racks. By way of explanation, equipment racks comprise of rails extending in a vertical direction and spaced a distance apart to support a plurality of modular housings disposed between the rails in vertical space. The modular housings are configured to support information processing devices, such as computer servers, data storage devices, and/or other circuits in the form of server blades, sometimes referred to as cards.

Conventional server blades are formed as conventional printed circuit board (PCB) server blades or cards. Conventional server blades or cards contain electrical traces for interconnecting electrical components mounted on the server blade or card. As bandwidth demands increase there is an unresolved need to provide server blades or cards that can transmit high-speed optical signals.

Optical fiber interfaces are also being employed in smaller, consumer electronic devices to provide the benefit of enhanced communications performance of optical fiber. Examples of such consumer electronics include, but are not limited to, personal computers, notebook computers, computer tablets, digital cameras, mobile phones, and other mobile devices. These consumer electronic devices also employ circuit boards such as printed circuit boards (PCB(s)) that route electrical signals between electrical components and circuits disposed in the PCB to perform the operations of the electronic devices. As bandwidth demand increases for these electronic devices there is also an unresolved need to provide solutions for carrying high-speed signals.

### SUMMARY

Disclosed are optical circuit board assemblies comprising a composite circuit board and one or more lens bodies in optical communication with the composite circuit board. The composite circuit board comprises a glass substrate and at least a first non-glass substrate, where the first non-glass substrate comprises at least one cutout that exposes a portion of the glass substrate.

In one embodiment the optical circuit board assembly comprises a composite circuit board comprising at least one optical trace for optical communication. The optical trace comprising one or more optical interfaces on the composite circuit board. The optical circuit board assembly also comprises one or more lens bodies. The one or more lens bodies comprising at least one optical channel that extends from a mating face to an optical interface portion of the lens body. The optical interface portion of the lens body is in optical communication with respective optical interfaces of the composite circuit board, and one or more lens bodies comprise a stepped profile comprising a planar mounting surface that extends rearward from the optical interface portion.

In another embodiment the optical circuit board assembly comprises a composite circuit board comprising a plurality of optical traces for optical communication. The composite circuit board comprising an end portion with an end surface and the plurality of optical traces having a respective end portion that is accessible at the end surface of the composite circuit board and the respective end portions arranged at one or more optical interfaces on the composite circuit board. The optical circuit board assembly also comprises at least one lens body comprising at least one optical channel that extends from a mating face to an optical interface portion of the lens body. The optical interface portion of the lens body is in optical communication with one of the optical interfaces of the composite circuit board. At least one receptacle body is attached to the composite circuit board, wherein the at least one receptacle body is aligned with the at least one receptacle body and a bezel mount is attached to the composite circuit board.

In another embodiment the optical circuit board assembly comprises a composite circuit board comprising a plurality of optical traces for optical communication. The plurality of circuit board optical traces are arranged at a plurality of optical interfaces on the composite circuit board. The composite circuit board has an end portion with an end surface and the optical traces having an end portion that is accessible at the end surface of the composite circuit board. The optical circuit board assembly also comprises a plurality of lens bodies with each lens body comprising at least one optical channel that extends from a mating face to an optical interface portion of the lens body, wherein the optical interface portion of the lens bodies are in optical communication with respective optical interfaces of the composite circuit board. The assembly comprises an attachment structure comprising a plurality of openings and is secured to the composite circuit board so that the plurality of openings are respectively arranged about the plurality of lens bodies

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments. [If there are no appended drawings, amend accordingly.

### BRIEF DESCRIPTION OF THE DRAWINGS

FIG. 1 is a rear perspective view showing various configurations of optical circuit board assemblies according to the concepts disclosed.

FIG. 2A is an exploded view and FIG. 2B is an assembled view of an explanatory composite circuit board comprising a glass substrate and at least one non-glass substrate, which may be used in the optical circuit board assemblies disclosed herein.

FIG. 3 is a close-up plan view showing a portion of the composite circuit board with a plurality of lens bodies that are in optical communication with optical traces of the composite circuit board (along with a counterpart line drawing to the right).

FIGS. 4 and 5 are perspective views showing details of the lens bodies depicted in FIG. 3.

FIGS. 6 and 7 are perspective views of another lens body suitable with the concepts disclosed that includes a receptacle body integrally formed with the lens body for allowing mating with a complimentary optical connector.

FIG. 8 is a perspective view showing an explanatory example of an optical circuit board assembly as part of an optical system.

FIGS. 9 and 10 are partially exploded views showing the composite optical circuit board as a portion of an optical circuit board assembly.

FIGS. 11a-11c depict various views of a bezel of FIG. 10.

FIG. 12 is an assembled side view showing the optical circuit board assembly of FIG. 8 mated with a suitable optical connector of a cable assembly.

FIG. 13 is a perspective view of another explanatory example of an optical circuit board assembly according to the concepts disclosed herein.

FIGS. 14 and 15 are perspective views showing the receptacle body before and after being attached to the optical circuit board assembly of FIG. 13.

FIG. 16 is a perspective view of optical connectors of respective fiber optic cable assemblies mated with the receptacle bodies of the optical circuit board assembly of FIG. 13 with the fiber optic cable and boot removed for clarity.

FIG. 17 is a longitudinal cross-sectional view of a connector of the fiber optic cable assembly mated with the receptacle body of the optical circuit board assembly of FIG. 16.

FIG. 18 is a perspective view of the optical circuit board assembly of FIG. 13 mounted to a faceplate along with a bezel as a portion of an optical system.

FIG. 19 is a partially exploded perspective view of the optical circuit board assembly of FIG. 18 along with other components of the optical system of FIG. 18 where the bulkhead is removed for clarity.

FIG. 20 is an end view of the optical circuit board assembly showing the lens body attached to the composite circuit board (along with a counterpart line drawing to the right).

FIGS. 21 and 22 are traverse cross-sectional views of the optical system showing the fiber optic cable assembly mated with the receptacles of the optical circuit board assembly of FIG. 18.

FIG. 23 is a longitudinal cross-sectional view of the optical system depicted in FIGS. 21 and 22 showing the fiber optic cable assembly mated with the receptacles of the optical circuit board assembly.

FIGS. 24 and 25 are perspective views of the insert of FIG. 23 (along with a counterpart line drawing in the middle).

FIG. 26 is a perspective view of the articulated receptacle frame.

FIG. 27 is a perspective view showing yet another optical circuit board assembly having an articulated receptacle frame.

FIG. 28 is a schematic view of an optical connection between a cable assembly and the optical circuit board.

### DETAILED DESCRIPTION

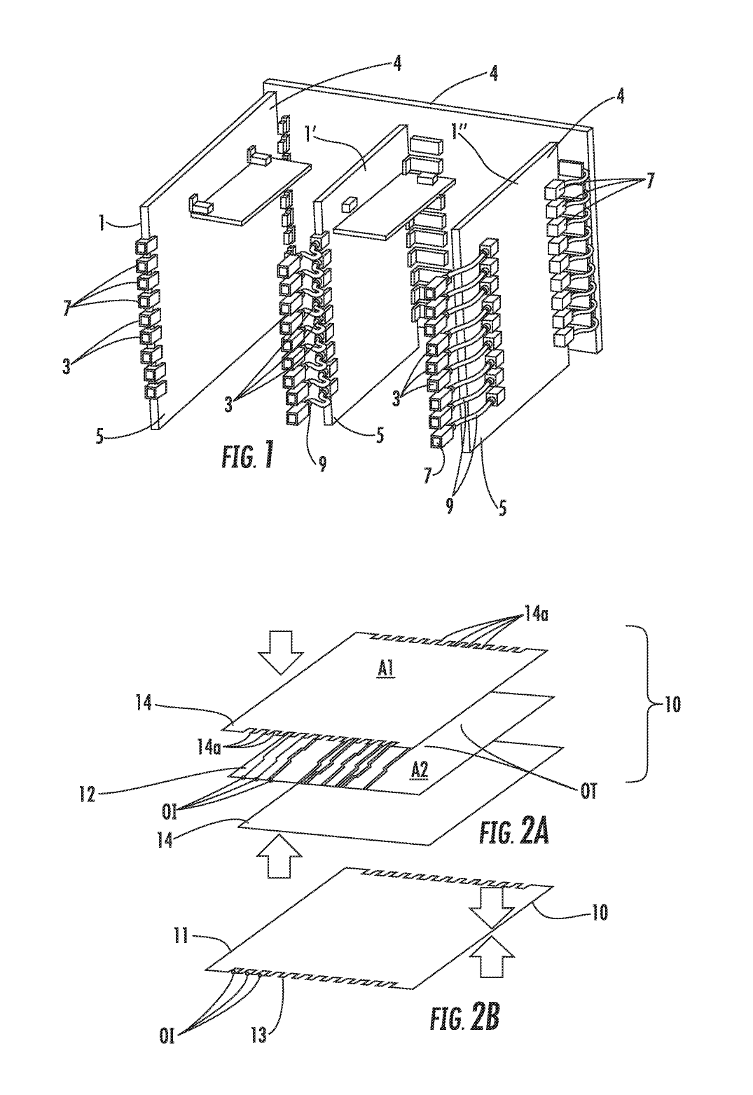

FIG. 1 is a perspective rear view showing various configurations of optical circuit board assembly 1, 1′ and 1″ according to the concepts disclosed. Optical circuit board assemblies 1,1′,1″ have respective optical interfaces 3 disposed at one or more of a front end portion 4 and a rear end portion 5 of the assembly for making optical connectivity to the composite circuit board disclosed. Embodiments of optical circuit board assemblies disclosed may have optical connections at one or more mid-span portions and/or end portions of the composite circuit board as desired for the given application.

Optical circuit board assembly 1 comprises optical interfaces 3 along with receptacles 7 for receiving a complimentary mating optical connector on opposing end portions 4,5 of the composite circuit board. Optical circuit board assembly 1′ has optical interfaces 3 disposed at the front end portion 4 along with receptacles 7 and the rear end portion 5 of assembly 1′ has flexible tethers 9 extending from the composite circuit board with connections such as plugs or receptacles 7 attached at the end of tethers 9 for making optical connections using a suitable optical connector. Variations of the concepts include composite optical circuit boards with mid-span portions attached with “fly-over” optical connections and jumpers that cross-a-portion of the composite circuit board.

Other variations of the concepts include optical connections at mid-span or end portions that use lens bodies capable of turning or steering the optical signal such as total-internal-reflection (TIR) lens bodies for coupling optical signals to the composite circuit board. Optical circuit board assembly 1″ has hybrid optical interfaces 3 such as receptacles disposed at the front end portion 4 for connection to a faceplate or wall of optical equipment and the rear end portion 5 has “fly-over” optical connections with TIR lens bodies having flexible tethers 9 extending with optical ports such as receptacles or plugs 7 attached to respective ends of the tethers 9 for making optical connections with another devices using a suitable optical connector. The “fly-over” optical connection may also include multiple connectors attached to a single extension by furcating the optical channels of the lens body into one or more distinct and/or different optical connectors.

FIG. 2A (above) is an exploded view and FIG. 2B (below) is an assembled view of an explanatory composite circuit board 10 (hereinafter “circuit board”) comprising a glass substrate 12 and at least a first non-glass substrate 14. In the explanatory embodiment depicted, a first non-glass substrate 14 (upper substrate) is shown with an one-sided major planar area A1 that is smaller than an one-sided major planar area A2 for the glass substrate 12 (middle substrate) due to the use of one or more cut-outs 14a in the first non-glass substrate 14. As depicted, the first non-glass substrate 14 comprises a plurality of cutouts 14a disposed on opposite ends of the circuit board 10 that expose portions of the glass substrate 12 of the circuit board 10. The at least one cutout 14a may be used for gross alignment of a lens body 20 to the circuit board 10 for allowing direct attachment of the lens body 20 to glass substrate 12. As another option, the cutout 14a in the non-glass substrate 14 may be used for providing a ledge or attachment point for a frame or mount; however, edge frame portions and mount portions disclosed may be attached at locations of the circuit board having one or more substrates as desired. Of course, circuit board assemblies disclosed may have multiple substrates that are attached or laminated together as desired such as a second non-glass substrate 14 (lower substrate in FIG. 2A) attached to the glass substrate 12.

Circuit board 10 has at least one optical trace OT for optical communication comprising one or more optical interfaces OI on the circuit board 10. Optical interface(s) OI are arranged for making an optical connection to the circuit board 10 at one or more locations. Optical interfaces OI may have one or more optical traces OT and be arranged in groups on circuit board 10. For instance, the optical traces OT may be arranged in groups of two, four, eight, ten or twelve optical traces on one or more end portions of the circuit board. Likewise, another portions of the circuit board may also include one or more optical interfaces OI as desired such as at a mid-span location. As shown, the at least one optical trace OT may be arranged on a portion of the glass substrate 12.

For instance, circuit board comprises an end 11 with an end surface 13 and the optical traces OT may have an end portion (not numbered) that is accessible at the end surface 13 of circuit board 10. The end portions of the optical traces OT may be used for optical communication with the circuit board 10. By way of explanation, further assemblies of optical circuit boards may further comprise one or more lens bodies or other components attached to the end portions of the optical traces OT so that optical channel(s) of the respective lens body are in optical communication with the optical interfaces OI of the circuit board. Further details and embodiments of the concepts are discussed herein.

Various methods exist for making optical traces (e.g., optical waveguides) on or in a glass substrate 12 and may be used with the concepts disclosed herein. For instance, glass substrates 12 may have optical traces OT written using physical or chemical thin-film deposition or may use a process that modifies the refractive index (RI) of the glass substrate 12 such as ion exchange or laser writing to create the optical trace OT. Other methods of forming the optical traces OT are also possible. More detailed examples of such methods are given in the paper from G. C. Righini and A. Chiappini, titled “Glass optical waveguides: a review of fabrication techniques” Optical Engineering 53(7), 071819 (July 2014), the contents of which are incorporated herein by reference,

As shown in FIG. 2A, upper non-glass substrate 14 has a pluralities of cutouts 14a arranged in arrays at opposing ends of the circuit board 10. Cutouts 14a may also be located at mid-span portions of the non-glass substrate 14 for creating “fly-over” locations in the circuit board such as depicted in FIG. 1. As depicted, circuit board 10 may optionally have more than one non-glass substrate 14 such as a sandwich construction of the glass substrate 12 by non-glass substrates 14. One manner of attaching substrates is by lamination, but any suitable arrangement or constructions are possible for the substrates of the circuit board 10. For instance, circuit boards disclosed could also use multiple glass substrates 12 for making distinct optical layers and optical traces/optical interfaces on the different optical layers. Additionally, circuit boards may also have electrical circuits in one or more the substrates for making hybrid optical/electrical circuit boards. For example, an electrical circuit may be disposed on the non-glass substrate 14 by using a conventional electrical circuit boards attached to glass substrate 12. Electrical connections on the non-glass substrates 14 could be wiping or sliding electrical connections at a surface or edge of the circuit board 10, electrical pads or solder locations, pins, etc. as known in the art. Further, the non-glass substrate 14 may comprise one or more photonic integrated circuits for processing opto-electrical signals or other electrical and/or optical components as desired.

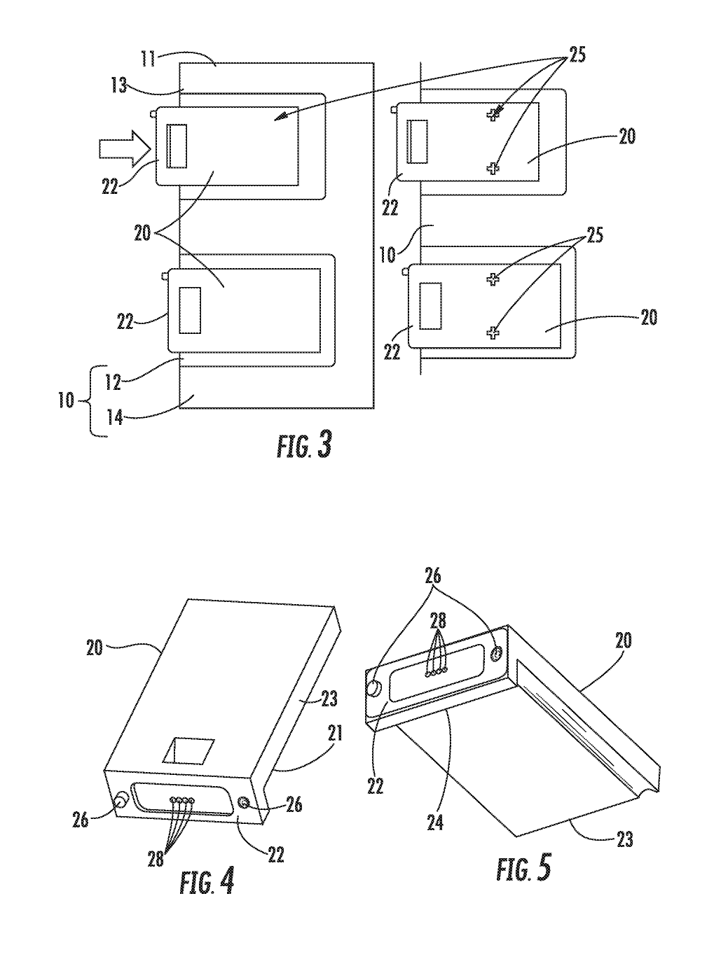

FIG. 3 depicts a portion of an explanatory circuit board 10 with one or more lens bodies 20 in optical communication with the optical traces OT of circuit board 10, thereby forming an explanatory optical circuit board assembly 100. FIGS. 4 and 5 are perspective views showing details of the lens bodies 20 depicted in FIG. 3. Circuit board 10 of FIG. 3 comprises an end portion 11 with an end surface 13 and the optical traces OT comprise respective end portions (not numbered) that are accessible at the end surface 13 of circuit board 10. Respective end portions of optical traces OT are in optical communication with the lens body 20. As schematically shown in FIG. 28, a complementary optical connector 320 may in optical communication with the lens body 20 for optical communication with the circuit board 10.

Lens body 20 comprises at least one optical channel OC that extends from a mating face 22 to an optical interface portion 24 of the lens body 20. The optical interface portion 24 of the lens body 20 is disposed behind the mating face 22 and cooperates with the optical interface OI of the circuit board 10 for optical communication therebetween. One or more lenses 28 may be disposed at the mating face 22 for coupling performance, but other locations on the lens body are possible for lenses 28. Lens body 20 is formed from a suitable optical polymer or the like for propagating optical signals therethrough. Any suitable methods and/or structures for attaching the lens bodies 20 to the circuit board 10 are possible such as adhesive, fasteners and the like.

The one or more lenses 28 of the body 20 provide an expanded beam optical connection that provides an essentially collimated optical beam for the optical interface of the circuit board 10. Further, the lenses 28 of the body 20 do not require physical contact of optical fibers or ferrules for optical communication. Since physical contact is not required between optical fibers or ferrules the concepts disclosed reduce the forces on the circuit board compared with designs and concepts that require physical contact between optical fibers or ferrules for optical communication. Further, the expanded beam optical connection provides a larger effective area for optical communication and is less susceptible to contamination such as dust, dirt and debris as well as providing larger tolerances for lateral and axial alignment.

The optical interface portion 24 of the lens body 20 is in optical communication with respective optical interfaces OI of circuit board 10. Any suitable alignment technique may be used for aligning the optical channels OC of the lens body 20 to the optical interface OI of circuit board 10 such as active and/or passive alignment. For instance, the circuit board 10 and/or lens body 20 may optionally include one or more alignment fiducials 25 for aiding alignment during manufacturing such as markings and/or openings on the circuit board 10 and/or lens body 20. Likewise, lens body 20 may comprise one or more alignment fiducials 25 that are registered with the optical interface portion 24 of the lens body 20. Alignment fiducials 25 on the lens body 20 allow the use of machine vision or the like to be used during alignment for precise placement.

As shown, lens bodies 20 of FIGS. 4 and 5 comprise a stepped profile 21 comprising a mounting surface 23 that extends rearward from the optical interface portion 24. Likewise, any suitable methods and/or structures for attaching the lens bodies 20 to the circuit board 10 are possible such as adhesive and the like. Consequently, mounting surface 23 provides a datum for attaching lens body 20 to circuit board 10; however, other structures and/or arrangements are possible for datums on lens bodies 20.

Lens body 20 may optionally comprises one or more alignment features 26 at the mating face 22 for optical alignment with a complimentary device. If multiple alignment features 26 are used they can be matched such as both bores or pins or mismatched as different alignment features 26. As depicted by FIG. 4, this optical body 20 has a first alignment feature 26 configured as a bore and a second alignment feature 26 configured as a pin. Lens body 20 comprises one or more lenses 28 at the mating face 22. Although depicted with four optical channels OC with each optical channel OC having an optical lens 28, the lens bodies 20 can have any suitable arrangement or construction.

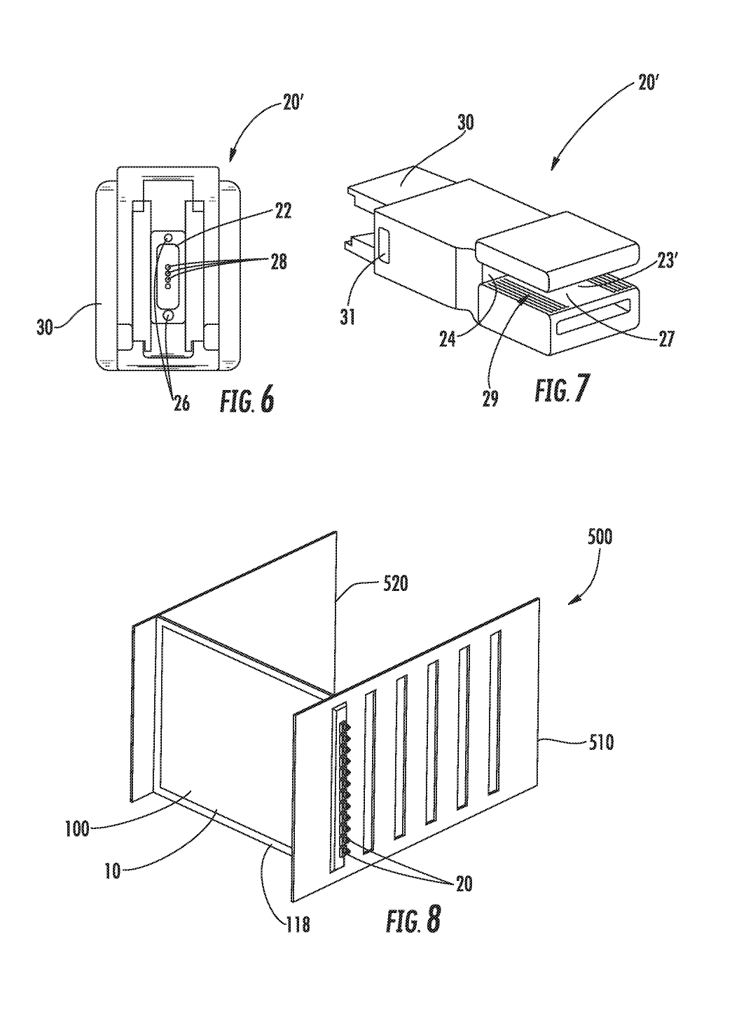

For instance, lens bodies 20′ may have other suitable constructions for alignment and attachment to circuit boards 10. Illustratively, FIGS. 6 and 7 are perspective views of another explanatory lens body 20′ suitable with the concepts disclosed. This lens body 20′ includes a receptacle body 30 integrally formed with the lens body 20′ for aiding mating with a complimentary optical connector. Integrally forming the receptacle body 30 with the lens body 20′ reduces the number parts, but it may allow the transfer of forces to circuit board 10 by way of the receptacle body. Thus, lens body 20′ may have other types of mounting surface(s) 23′ extending rearward from the optical interface portion 24′ to support loads and side forces. By way of explanation, lens body 20′ has a mounting surface 23′ comprising a slot 27 extending rearward from the optical interface portion 24′. Slot 27 allows support for the lens body 20′ on both sides of circuit board 10.

Additionally, lens bodies can have other features for securing the lens bodies so that it is in optical communication with the circuit board. Portions of the mounting surface 23 or slot 27 may comprise one or more relief grooves 29 for receiving adhesive such as epoxy or the like. Lens bodies may also have one or more openings for inserting adhesive or venting of air. Lens bodies may also comprise latching windows 31 for attaching complimentary connectors and the like.

FIGS. 8-10 depict circuit board 10 as a portion of an explanatory optical circuit board assembly 100 in various states. FIG. 8 depicts optical circuit board assembly 100 as a part of an optical system 500. Optical system 500 has a front bulkhead 510 where the lens bodies 20 are accessible for optical interconnection with complementary optical connectors and an optical backplane at the rear for optical attachment with another optical circuit 520. Other variations of optical systems are also possible according to the concepts disclosed.

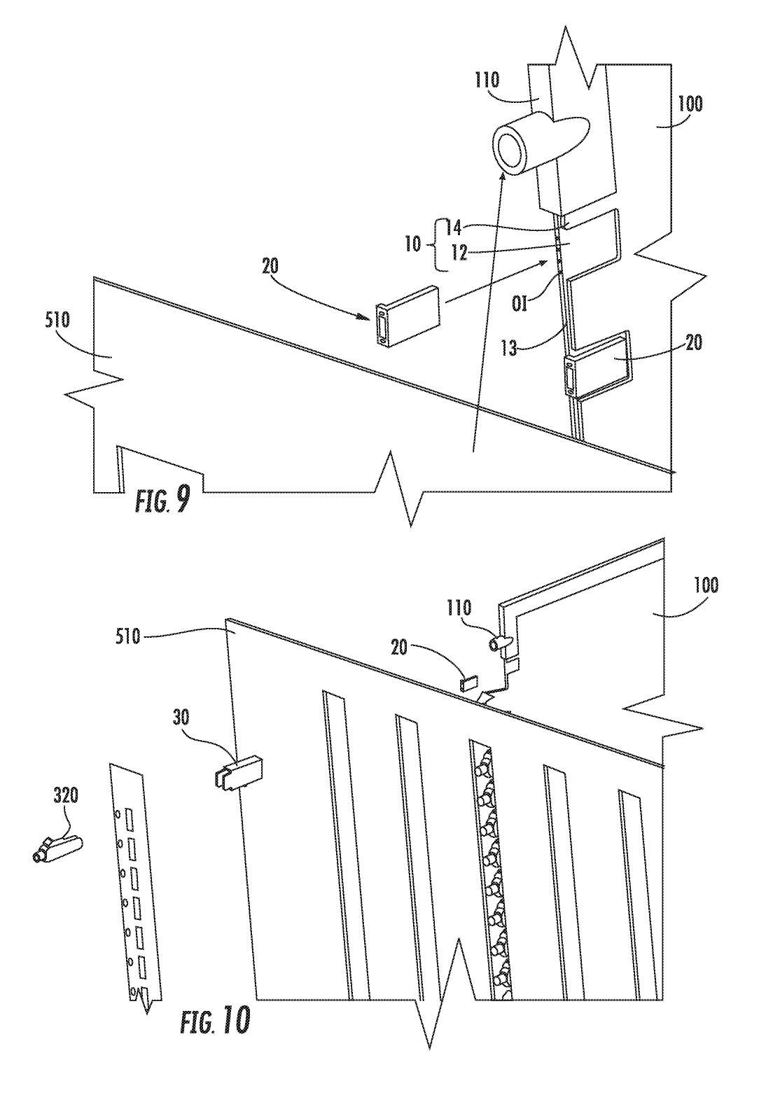

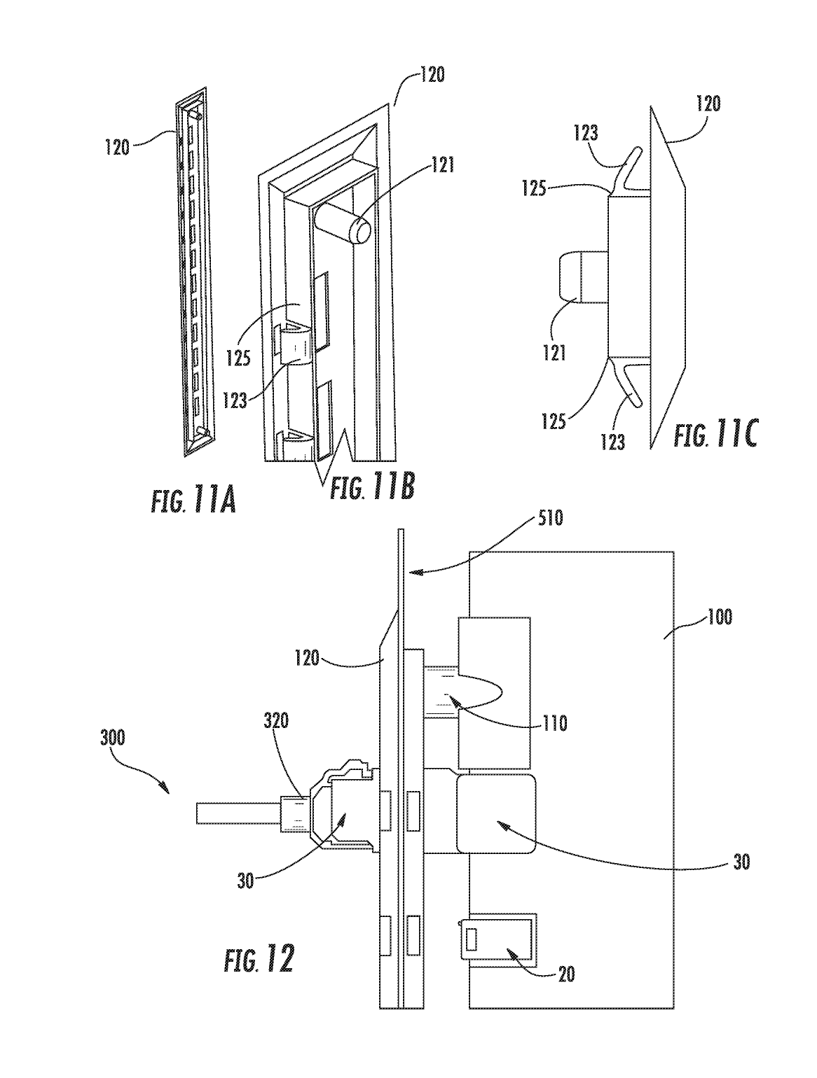

FIGS. 9 and 10 are partially exploded views showing portions of an optical circuit board assembly 100 at the front bulkhead 510 of optical system 500. Optical circuit board assembly 100 further comprises one or more bezel mounts 110. The at least one bezel mount 110 allows a bezel to be aligned with the circuit board assembly 100 and then attached to the bezel mount 110. As depicted, bezel mount 110 is attached to circuit board 10. Bezel mounts 110 can be mounted to the circuit board 10 individually or be a portion of an optional support frame 118 for protecting and providing rigidity to the circuit board 10. Support frame 118 may extend over a perimeter portion of the circuit board 10 as desired such as on one or more sides. Support frame 118 may be used as a guide for sliding optical circuit boards into position within a guide of the optical system 500. Other components may be used for protecting edges of the circuit boards such as rubber edging or the like.

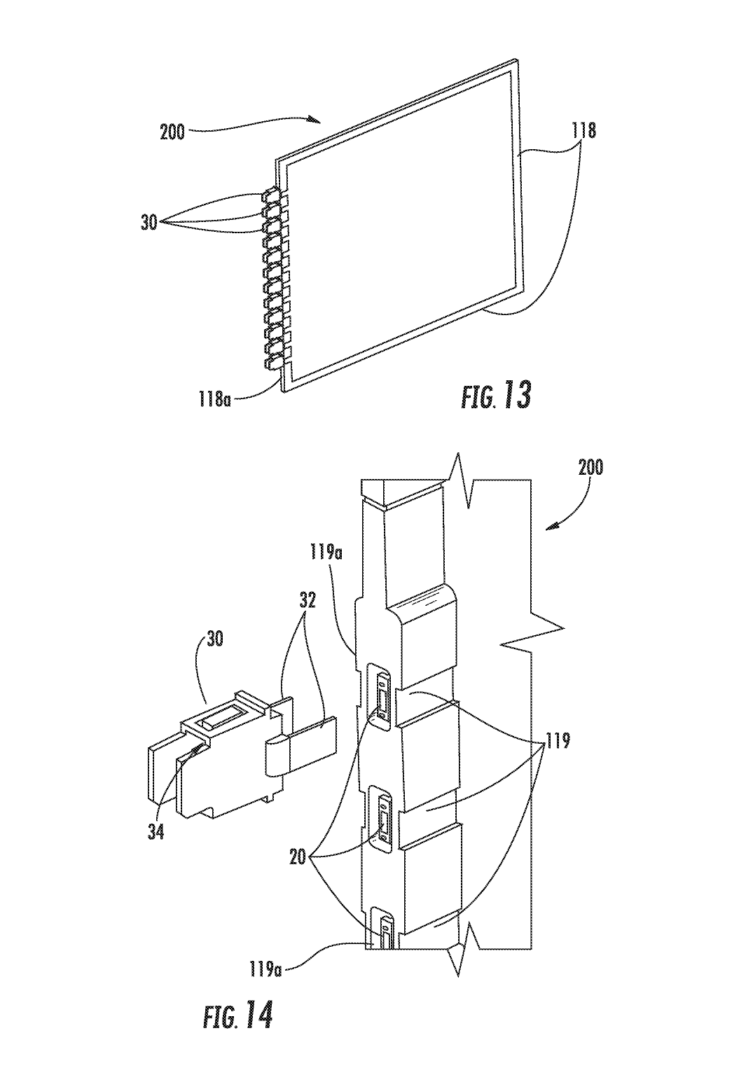

As depicted in FIG. 10, a receptacle body 30 is shown before being attached about lens body 20. Receptacle body 30 is used for aligning the optical channels OC of lens body 20 with the optical channels of a complimentary connector 320. When the circuit board is assembled to the optical system 500 a portion of the receptacle body 30 may extend beyond the bezel 120. FIGS. 11a-11c depict various views of the bezel 120 showing details of the same. As shown, bezel 120 has one or more posts 121 such as at the top and bottom along with one or more latches 123 arranged about a wall 125 at the rearside of the bezel 120 for aligning and securing the bezel 120 to the bulkhead 510.

FIG. 12 is an assembled side view showing the optical circuit board assembly 100 mated with a suitable complimentary optical connector 320 of a cable assembly 300 for optical communication therewith. In this embodiment, the bezel 120 attaches to the bezel mount 110 so that the receptacle body 30 is not secured to the bulkhead 510 or the bezel 120. Stated another way, the respective openings (not numbered) in the bulkhead 510 and the bezel 130 for receiving the receptacle body 30 are larger than the dimensions of the receptacle body 30 so that the receptacle body 30 is not constrained by the respective openings. Specifically, the posts 121 are received in complementary sized bores of the bezel mounting structure 110. Once assembled one end of receptacle body 30 is exposed at the bezel 130 for receiving a complimentary optical connector and making optical communication with the circuit board assembly 100. FIG. 28 schematically depicts an optical connection between the lens body 20 and the complimentary mating optical connector 320.

FIGS. 13-17 depict views of another explanatory example of an optical circuit board assembly 200 according to the concepts disclosed herein, which is similar to optical circuit board assembly 100. FIGS. 18-23 depict an optical circuit board assembly 500 that uses optical circuit board assembly 200.

FIG. 13 depicts the assembled optical circuit board assembly 200 and FIGS. 14 and 15 depict the receptacle 30 before and after being attached to the optical circuit board assembly 200. As depicted, optical circuit board assembly 200 comprises a circuit board 10 with one or more lens bodies 20 with the respective optical interface portion 24 of the lens bodies 20 being in optical communication with the respective optical interfaces OI of the circuit board 10. One or more receptacles 30 may be aligned and attached to the assembly 200 about the respective lens bodies.

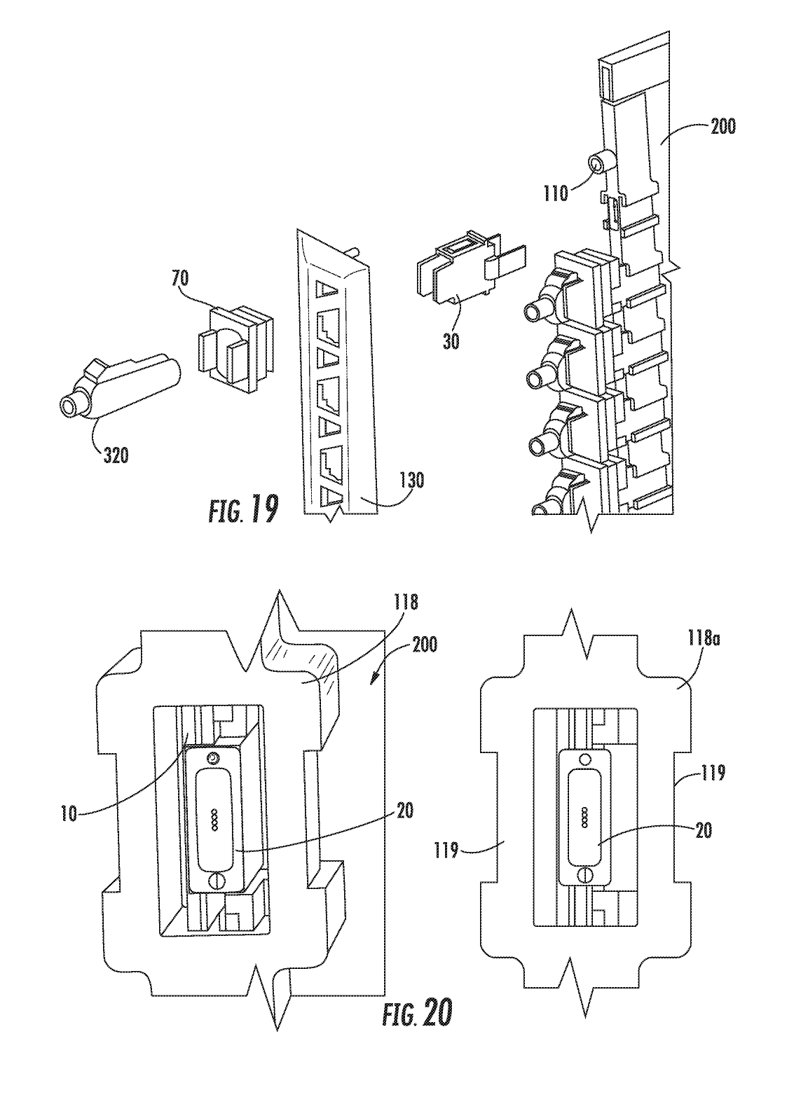

In this embodiment, the optional support frame 118 extends around the entire perimeter of circuit board 10. Support frame 118 may be modular and comprises one or more pieces. A front portion 118a of the support frame 118 comprises an attachment structure 119 having one or more openings 119a. Attachment structure 119 is secured to the circuit board 10 so that the one or more openings 119a are respectively arranged and/or aligned about the respective lens bodies 20 as best shown in FIG. 20. The front portion 118a receives and secures receptacle bodies 30 and the front portion 118a aligns the receptacle bodies 30 with the respective lens bodies 20. The front portion 118a may even be formed in more than one pieces to inhibit tolerance stack-up across an array of lens bodies 20

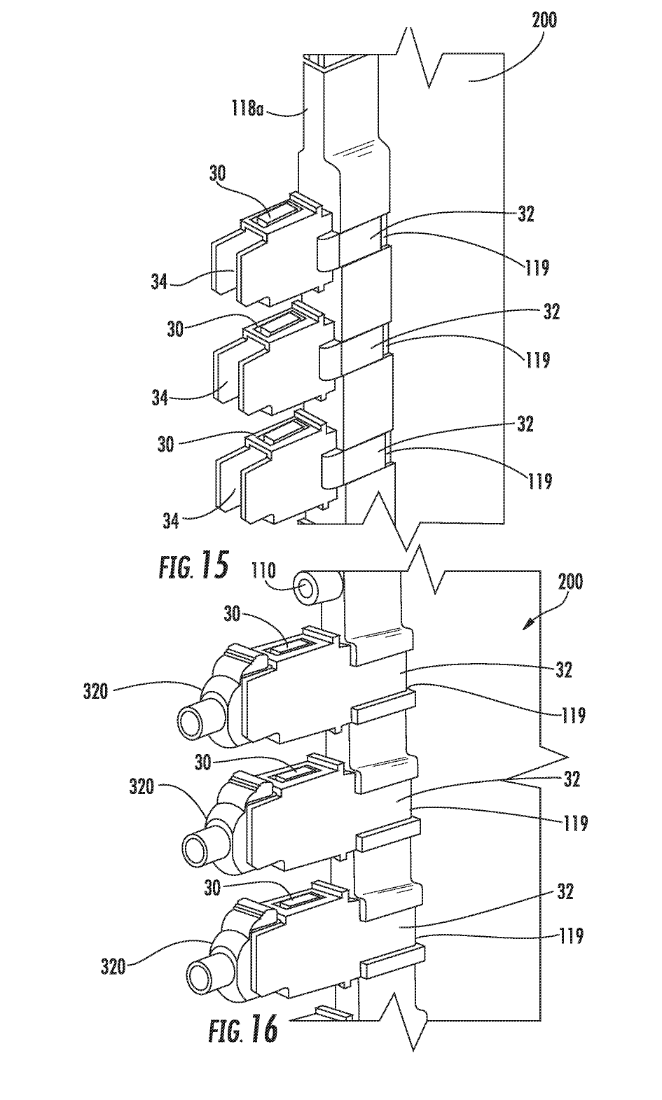

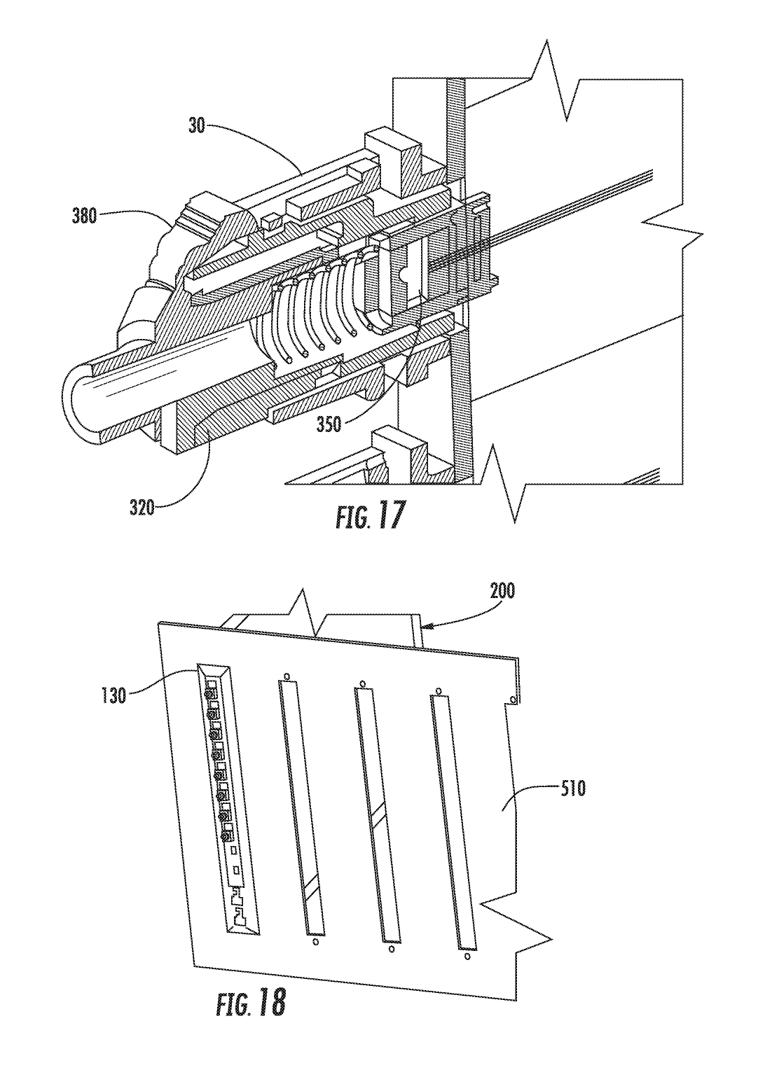

Receptacle bodies 30 may have cantilevered latch arms 32 that snap-fit to the attachment structure 119 of the front portion 118a, but other suitable attachment methods such as fasteners, adhesives and the like are possible. Receptacle bodies 30 have a passageway 34 therethough and the free end of receptacle body 30 is configured for receiving a complimentary optical connector 320 for making an optical connection. FIG. 16 is a perspective view depicting the respective optical connector 320 of the fiber optic cable assemblies 300 mated with the receptacle bodies 30.

FIG. 17 is a longitudinal cross-sectional view of the optical connector 320 of the fiber optic cable assembly mated with the receptacle of FIG. 16 with the fiber optic cable and boot removed from the cable assembly for clarity. Optical connector 320 comprises a ferrule 350 having its optical channels aligned with the lens body 20 for optical communication and a connector housing 380 for engaging with the receptacle body 30. An example of the type of optical connector that may be used with the concepts disclosed is the MXC™ plug connector available from USConec of Hickory, N.C. Although, the optical connector 320 illustrated biases the ferrule 350 forward, other suitable connectors can have other configurations.

FIG. 18 is a perspective view showing the optical circuit board assembly 200 mounted to a bulkhead 510 along with a bezel 130 and FIG. 19 is a partially exploded perspective view of the optical circuit board assembly 200 with the bulkhead removed for clarity. As depicted, an optional insert 70 may attached to the receptacle body 30 and is used for stabilizing and accommodating tolerance variations of the optical ports of the circuit board with respect to the bezel 130 and bulkhead 510.

FIG. 20 is an end view of the optical circuit board assembly 200 showing the lens body 20 that is accessible via the opening 119a of attachment structure 119. As depicted, attachment structure 119 has recessed portions (not numbered) on each side of opening 119a for aligning and receiving the cantilevered latch arms 32 of receptacle body 30. The recessed portions and the cantilevered latch arms 32 provide gross alignment with the lens body 20. Ledges or a frame on the engagement face of the receptacle body may be used for providing fine alignment with the opening 119a of the attachment structure 119 as desired and/or the fine alignment may be provided by structure on the optical connector such as the connector housing.

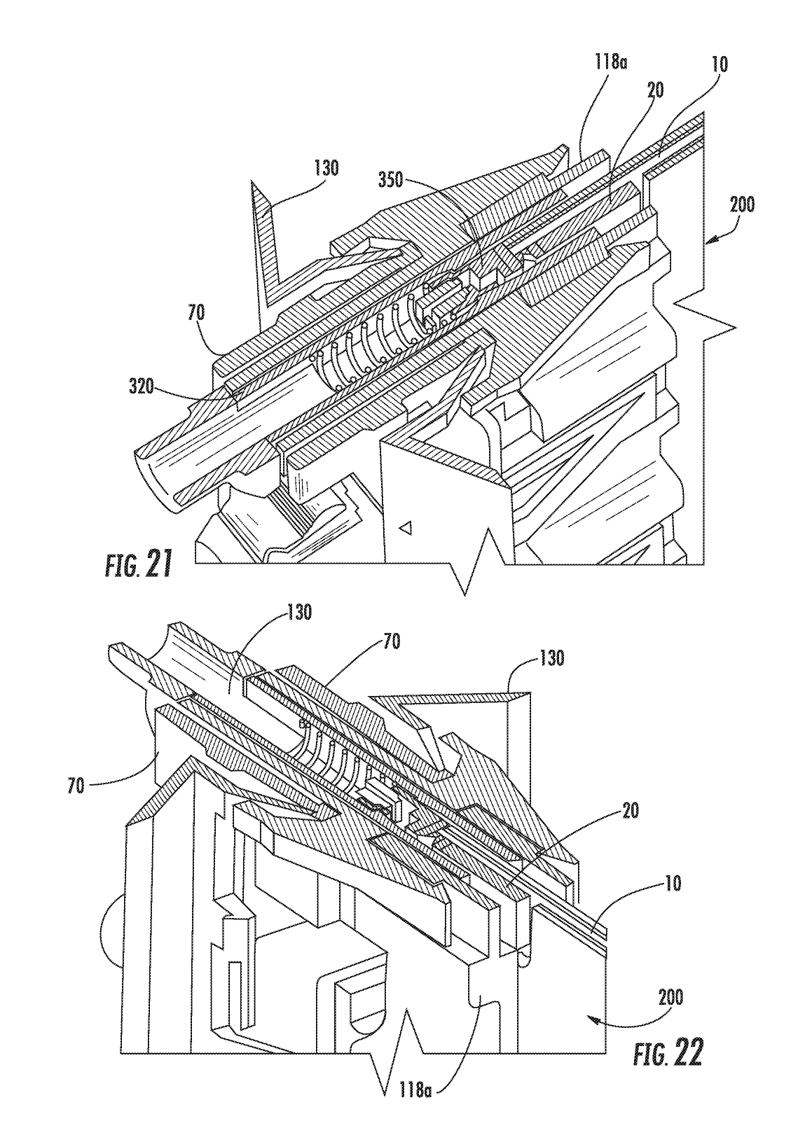

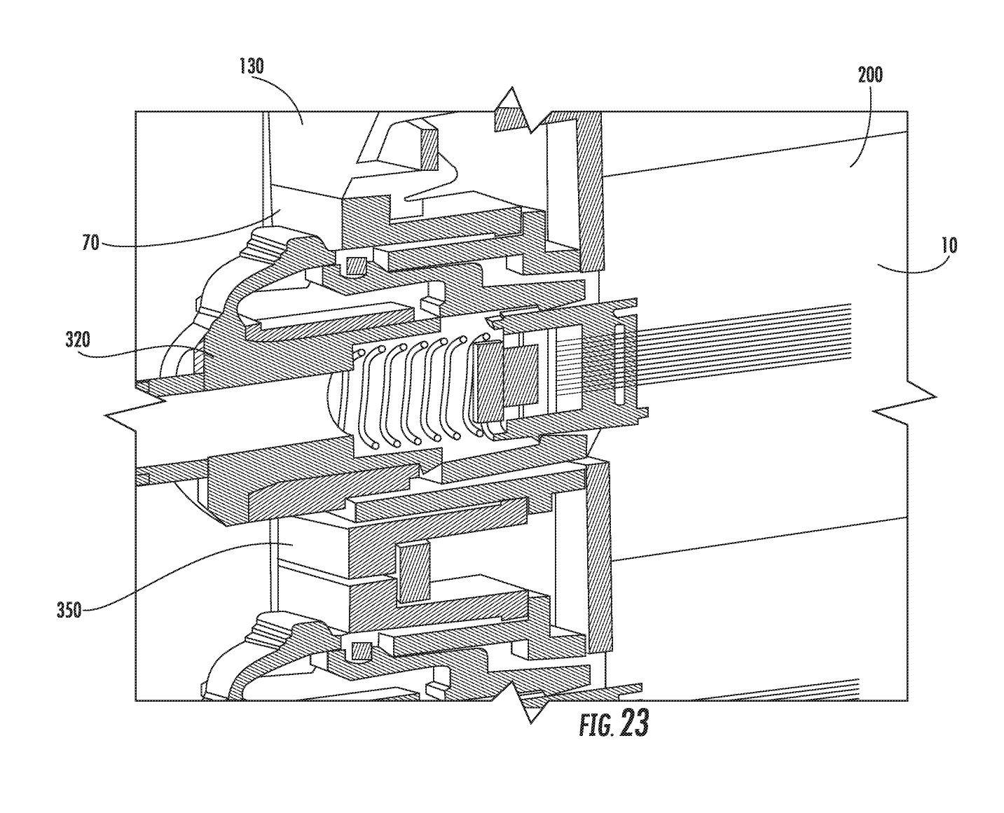

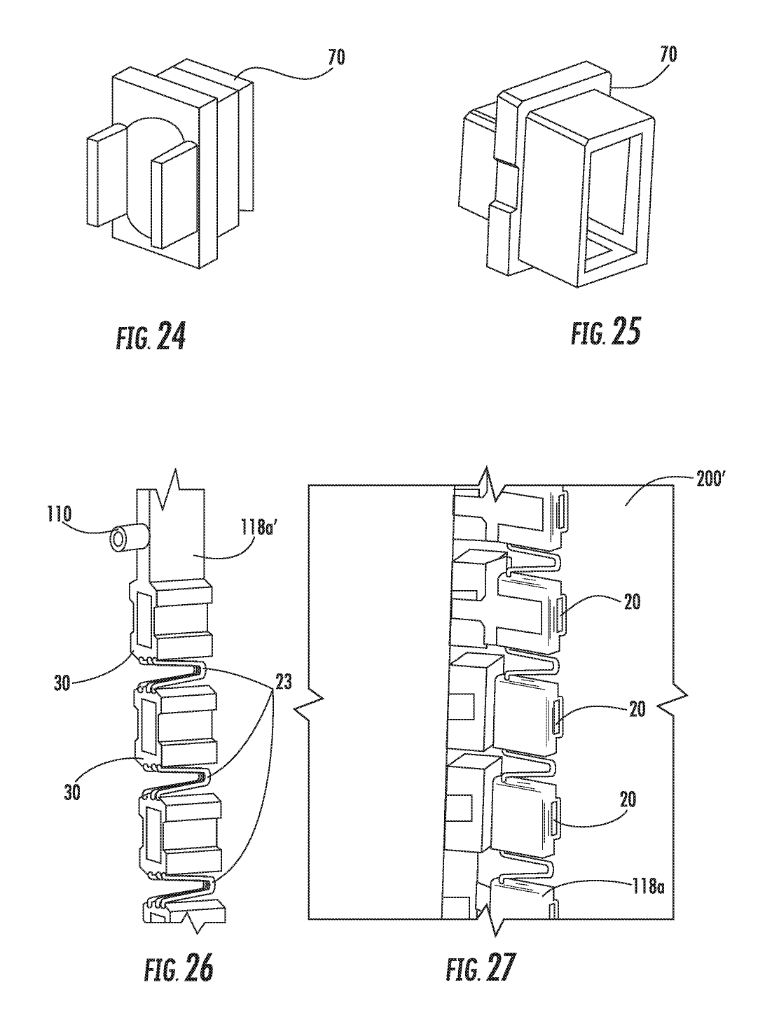

FIGS. 21 and 22 are traverse cross-sectional views of the optical connector 320 mated with the receptacle 30 of the optical circuit board assembly of 200 showing details from different angles. As depicted, the insert 70 may be inserted into and attached to the bezel 130 to secure the optical circuit board assembly 200 to the bezel 130. FIG. 23 is a cross-sectional view of another optical circuit board assembly taken along a longitudinal axis that comprises an insert mounted to the faceplate. FIGS. 24 and 25 are perspective views of the insert 70 showing details of the same (along with a counterpart line drawing of the insert in the middle of the FIGS.).

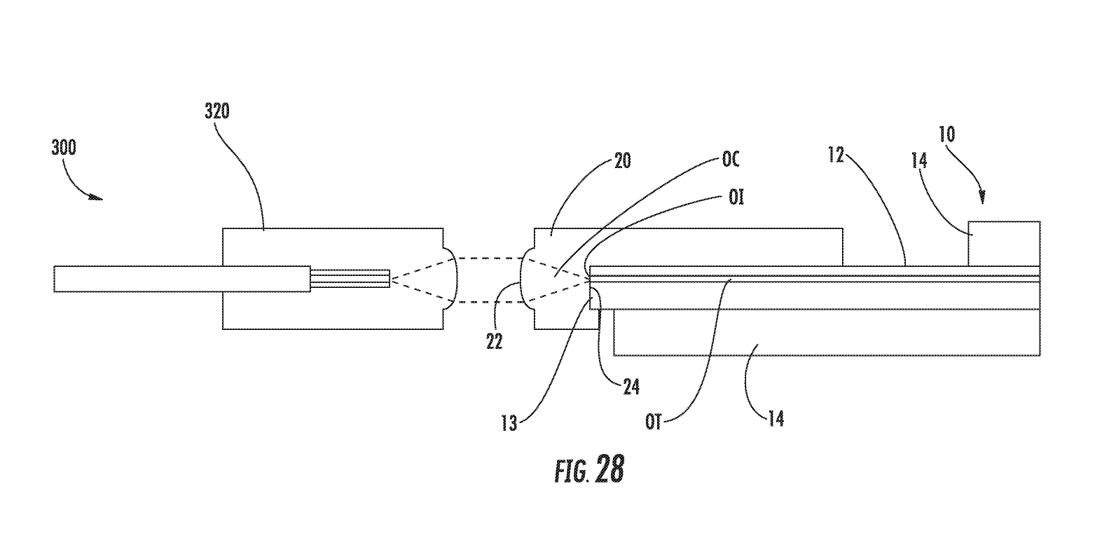

Other variations of parts and/or constructions are possible according to the concepts disclosed. FIG. 26 is a perspective view of the articulated receptacle frame 118a′. Articulated receptacle frame 118a′ comprises a plurality of receptacles 30 that are joined together by a plurality of web portions 123. Web portions 123 are flexible and allow a certain degree of repositioning each individual receptacle 30 about the respective lens body 20 when securing the articulated receptacle frame 118a′ to the circuit board. For instance, a positioning jig may be used for precisely positioning the receptacles 30 about each lens body 20. Consequently, there is less concern about tolerance stack-up with the alignment of the articulated receptacle frame 118a′ with the plurality of lens bodies 20. FIG. 27 is a perspective view showing yet another optical circuit board assembly 200′ comprising the articulated receptacle frame of 118a′.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the application should be construed to include everything within the scope of the appended claims and their equivalents.

What is claimed is:

1. An optical circuit board assembly, comprising:
a composite circuit board comprising a glass substrate and at least a first non-glass substrate, wherein the first non-glass substrate comprises at least one cutout that exposes a portion of the glass substrate;
the composite circuit board comprising at least one optical trace for optical communication comprising one or more optical interfaces on the composite circuit board; and
one or more lens bodies comprising at least one optical channel that extends from a mating face to an optical interface portion of the lens body, wherein the optical interface portion of the lens body is in optical communication with respective optical interfaces of the composite circuit board, and one or more lens bodies comprise a stepped profile comprising a planar mounting surface that extends rearward from the optical interface portion.

2. The optical circuit board assembly of claim 1, the composite circuit board having the glass substrate laminated to the first non-glass substrate.

3. The optical circuit board assembly of claim 1, the composite circuit board having an end portion with an end surface and the optical traces having an end portion that is accessible at the end surface of the composite circuit board.

4. The optical circuit board assembly of claim 1, wherein the composite circuit board further includes electrical traces.

5. The optical circuit board assembly of claim 4, wherein the electrical traces are a portion of the non-glass substrate.

6. The optical circuit board assembly of claim 1, the composite circuit board having the first non-glass substrate arranged on a first side of the glass substrate and a second non-glass substrate arranged on a second side of the glass substrate.

7. The optical circuit board assembly of claim 1, wherein the at least one optical trace is disposed on a portion of the glass substrate.

8. The optical circuit board assembly of claim 1, one or more receptacle bodies attached to the composite circuit board, wherein the one or more receptacle bodies are aligned with the one or more lens bodies, respectively.

9. The optical circuit board assembly of claim 1, further including a bezel mount attached to the composite circuit board.

10. The optical circuit board assembly of claim 1, further comprising at least one bezel mount attached to the composite circuit board and a bezel attached to the bezel mount.

11. The optical circuit board assembly of claim 1, further comprising an attachment structure having one or more openings, the attachment structure is secured to the composite circuit board so that the one or more openings are respectively arranged about the one or more lens bodies, respectively.

12. The optical circuit board assembly of claim 11, the attachment structure further comprising one or more attachment features respectively disposed adjacent to one or more openings of the attachment structure.

13. The optical circuit board assembly of claim 12, further comprising one or more receptacle bodies, the one or more receptacle bodies being respectively attached to the one or more attachment features of the attachment structure.

14. The optical circuit board assembly of claim 10, further comprising a bezel comprising one or more openings for one or more the lens bodies, the bezel being attached to the attachment structure.

15. The optical circuit board assembly of claim 1, one or more of the lens bodies comprising a stepped profile comprising a mounting surface that extends from the optical interface portion.

16. The optical circuit board assembly of claim 1, one or more of the lens bodies comprising a notch comprising a mounting surface that extends from the optical interface portion.

17. The optical circuit board assembly of claim 1, one or more of the lens bodies comprising an integrally formed receptacle bodies for alignment during optical mating.

18. The optical circuit board assembly of claim 1, wherein the optical circuit board assembly is part of an optical system.

19. An optical circuit board assembly, comprising:
a composite circuit board comprising a glass substrate and at least a first non-glass substrate, wherein the first non-glass substrate has at least one cutout that exposes a portion of the glass substrate;
the composite circuit board comprising a plurality of optical traces, the composite circuit board comprising an end portion with an end surface and the plurality of optical traces having a respective end portion that is accessible at the end surface of the composite circuit board and the respective end portions arranged at one or more optical interfaces on the composite circuit board;
at least one lens body comprising an least one optical channel that extends from a mating face to an optical interface portion of the lens body, wherein the optical interface portion of the at least one lens body is in optical communication with one of the optical interfaces of the composite circuit board;
at least one receptacle body attached to the composite circuit board, wherein the at least one receptacle body is aligned with the at least one lens body respectively; and
a bezel mount attached to the composite circuit board.

20. The optical circuit board assembly of claim 19, the composite circuit board having the glass substrate attached to the first non-glass substrate.

21. The optical circuit board assembly of claim 19, wherein the composite circuit board further includes electrical traces.

22. The optical circuit board assembly of claim 21, wherein the electrical traces are a portion of the non-glass substrate.

23. The optical circuit board assembly of claim 19, the composite circuit board having the first non-glass substrate arranged on a first side of the glass substrate and a second non-glass substrate arranged on a second side of the glass substrate.

24. The optical circuit board assembly of claim 19, wherein the plurality of circuit board optical traces are a portion of the glass substrate.

25. The optical circuit board assembly of claim 19, further comprising a bezel mount attached to the composite circuit board and a bezel attached to the bezel mount.

26. The optical circuit board assembly of claim 19, one or more of the plurality of lens bodies comprising a stepped profile comprising a mounting surface that extends from the optical interface portion.

27. The optical circuit board assembly of claim 19, one or more of the plurality of lens bodies comprising a notch comprising a mounting surface that extends from the optical interface portion.

28. The optical circuit board assembly of claim 19, wherein the optical circuit board assembly is part of an optical system.

29. An optical circuit board assembly, comprising:
a composite circuit board comprising a glass substrate and at least a first non-glass substrate, wherein the first non-glass substrate has at least one cutout that exposes a portion of the glass substrate;
a plurality of circuit board optical traces arranged at a plurality of optical interfaces on the composite circuit board, the composite circuit board comprising an end portion with an end surface and the optical traces having an end portion that is accessible at the end surface of the composite circuit board;
a plurality of lens bodies, each lens body comprising at least one optical channel that extends from a mating face to an optical interface portion of the lens body, wherein the optical interface portion of the lens bodies are in optical communication with respective optical interfaces of the composite circuit board; and
an attachment structure comprising a plurality of openings, the attachment structure is secured to the composite circuit board so that the plurality of openings are respectively arranged about the plurality of lens bodies.

30. The optical circuit board assembly of claim 29, the composite circuit board having the glass substrate attached to the first non-glass substrate.

31. The optical circuit board assembly of claim 29, wherein the composite circuit board further includes electrical traces.

32. The optical circuit board assembly of claim 31, wherein the electrical traces are a portion of the non-glass substrate.

33. The optical circuit board assembly of claim 29, the composite circuit board having the first non-glass substrate arranged on a first side of the glass substrate and a second non-glass substrate arranged on a second side of the glass substrate.

34. The optical circuit board assembly of claim 29, wherein the plurality of circuit board optical traces are a portion of the glass substrate.

35. The optical circuit board assembly of claim 29, the attachment structure further comprising a plurality of attachment features respectively disposed adjacent to the plurality of openings of the attachment structure.

36. The optical circuit board assembly of claim 29, further comprising a plurality of receptacle bodies, the plurality of receptacle bodies being respectively attached to the plurality of attachment features of the attachment structure.

37. The optical circuit board assembly of claim 29, further comprising a bezel comprising a plurality of openings, the bezel being attached to the attachment structure.

38. The optical circuit board assembly of claim 29, one or more of the plurality of lens bodies comprising a stepped profile comprising a mounting surface that extends from the optical interface portion.

39. The optical circuit board assembly of claim 29, one or more of the plurality of lens bodies comprising a notch comprising a mounting surface that extends from the optical interface portion.

40. The optical circuit board assembly of claim 29, wherein the optical circuit board assembly is part of an optical system.
